(19) United States
(12) Patent Application Publication
(10) Pub. No.: US 2003/0004816 A1
(43) Pub. Date: Jan. 2, 2003

(54) User-specific method of selling products, computer program product, and system for performing the same

(76) Inventors: Robert Andrew Byers JR., Thousand Oaks, CA (US); Dan Pearson, El Segundo, CA (US); Mark Conner, Northridge, CA (US); Jennifer Hamilton, Canyon Country, CA (US)

Correspondence Address: Lawson, Philpot & Persson, P.C., Suite 110, 67 Water Street, Laconia, NH, 03246, US

(21) Appl. No.: 09/892,800

(22) Filed: Jun. 27, 2001

(51) Int. Cl. G06F 17/60

(52) U.S. Cl. 705/26

(57) ABSTRACT

A method, computer program product and system for selling products over an electronic network. The method includes the steps of identifying a user and transmitting a user specific order entry form to the user. The order entry form includes at least one user specific product, a user specific price for each product, and a quantity entry field for each product. The seller receives a quantity of each product entered into the quantity entry field by said user and transmits a shopping cart that includes each product selected by the user. The customer then confirms that the order is correct and sends an instruction to the process an order, which is received by the seller and acted upon.

### FIELD OF THE INVENTION

The present invention relates to the field of selling and purchasing and, in particular to methods of selling healthcare products via a preloaded, user-specific template on the Internet.

### BACKGROUND OF THE INVENTION

In recent years, the Internet has matured into a robust medium both for the dissemination of information and for the consummation of commercial transactions. Such commercial transactions have typically been characterized as “C2C”, “B2C” and “B2B” transactions.

“C2C” transactions are consumer-to-consumer transactions that are carried out via a central hub site operated by a third party, such as eBay, Yahoo Auctions, or the like, who generally to anonymously browse, but requires all customers to register in order to sell or buy products. These transactions are product specific rather than relational, with few buyers and sellers conducting other business in the future.

“B2C” transactions are business-to-consumer transactions that are carried out at a web site controlled by the seller, such as Amazon, BestBuy, Travelocity, etc., who also will generally allow customers to anonymously browse, but requires all customers to register in order buy products. These transactions are not product specific, in the fact that a great number of products are available for purchase at a particular price that is set by the seller. However, there is often a relational aspect to B2C transactions, allowing sellers to target advertising or discounts to prior users. The price in B2C transactions is set by the seller and is often the same for all customers, although some sites have begun to set pricing for their products or services based upon user profiling, while others have utilized various types of auctions, reverse auctions or other specific pricing methodologies to set their prices. Once a product is ordered, the user will immediately pay for the product via credit card, virtual wallet, or other art recognized payment option, and the product will be shipped to its desired address. Subsequent orders will often not require any additional registration, but there will generally be no subsequent purchase of the same product by the buyer from the seller.

The third type of transactions is “B2B”, or business-to-business, transactions. These transactions may take on the flavor of B2C transactions, such as when small businesses purchase from large suppliers, such as Staples, Office Depot, etc. However, even these types of transactions are highly relational, with repeat purchases of certain items being highly likely. This relational aspect provides the seller with an incentive to please the customer, and provides him with the information necessary to customize his order processing in order to best do so. However, despite the relational aspects of B2B transactions, and the advantages that it offers, this marketplace has largely adopted the B2C approach to the selling/purchasing function. This failure in approach has contributed to the tendency of business customers to continue to purchase through traditional channels.

B2C has been very successful and popular due to the fact that purchases are usually not part of a work environment, and the option is to go find the product in a store and drive to purchase it. This is much less convenient than ordering on line with regards to the ordering aspect itself. Further, the ability to order at any time of the day or night has added to the convenience.

B2B on the other hand is quite the opposite in many ways and presents much different challenges than B2C. The business community either has a system of manually mailing, faxing or calling in purchase orders to the same suppliers on a regular basis. It is well known that the most efficient manner of ordering from these regular suppliers is total integration electronically through what is commonly known as EDI, which requires no manual interface.

Unfortunately, although many B2B marketplaces have promoted purchasing via their website, most businesses will not manually enter orders on a website purchase order due not only to their belief that it is faster to call or fax the order to the supplier, but also due to the inherent problems of inserting an improper part number and, more importantly, the lack of accurate pricing for the purchaser from the supplier on the website.

This fact appears to be true in all areas of business, but especially within the healthcare community where supplier sites may, at times, provide the ability to order, along with providing information about purchase histories and order status, but are infrequently used due to the potential for errors on ordering, the slowness of doing so and the difficulty of utilizing sales histories effectively. In these current systems, obtaining an up to date order status is probably the most successful reason to use supplier sites rather than traditional purchasing.

Current B2B systems have a number of drawbacks. First, these systems do not typically provide customer specific pricing. In the B2B context, this pricing may be set by a specific quote, or by prior course of dealings between the parties. However, the price to be paid is generally known prior to the purchaser seeking to place an order and can be displayed and visually confirmed by the purchaser. Second, the B2C model has no need for the display of past quotes or purchases, or to associate a buyer identification numbers with a particular product, as users are unlikely to purchase the same item more than once. However, this is the “bread and butter” of B2B transactions. Third, payment for B2C transactions is typically made at the conclusion of the transaction, which is contrary to traditional business practices.

Finally, many B2B systems fail to utilize the best features found in the B2C marketplace. These include the provision of customer specific product information, including peer reviews, “best practices” guides and the like, as well as the automatic electronic confirmation of orders and shipments.

Accordingly, there is a need for a method of selling, and a system computer program product for performing this method, that provides customer specific pricing, that displays past quotes and purchases, that allows a buyer to associate his own identification numbers with a particular product sold by the seller, that allows for payment “on account” under pre-agreed terms, that provides customer specific product information, including peer reviews, product protocols, “best practices” guides and the like, and that provides an automatic electronic confirmation of orders and shipments.

### SUMMARY

The present invention is a method, computer program product and system for selling that makes Internet purchasing the most efficient, simplest, and fastest form of procurement for purchasers of products, such a healthcare equipment and supplies. The present invention provides a registered customer with the ability to simplify the purchase of products via a preloaded, user-specific order entry form on the Internet. The customer accesses a user-specific order entry form through a client system. The form reflects user-specific contract pricing and user-specific purchasing history. Products on the form consist of products ordered from the seller over a designated number of days. By simply entering the quantity for purchase next to the line item and processing the method of payment, such as via a purchase order, credit card, or the like, the user's purchase order is complete.

In a preferred embodiment, the purchaser is a purchaser of healthcare products who uses a client system to enter quantities of these products in an HTML document supplied by the server system. This document is preferably supplied over the Internet in response to the identification of an IP address, password, cookie, or other authentication, of the customer accessing to the site. The HTML document supplied to the customer contains a user-specific order template entry form preloaded with information. This information preferably includes a listing of each product purchased from the seller in the past 30, 60, 90, 120 or more days, the user-specific price for each product, links to product photographs, clinical information, product availability, peer reviews, protocols, the product's content of certain compounds, such as latex or PVC (polyvinyl chloride), and UPN/barcode information, even though the product packaging may not contain all such information.

Once the customer has entered information onto the entry form, the client and server systems subsequently exchange information entered by the purchaser, preferably on HTML screens supplied by the server system. These screens are a virtual “shopping cart” showing products added by the purchaser from the ordering template, order payment type and purchase order number, if such a number is supplied. The server system then processes this order information and preferably e-mails an order confirmation to the purchaser.

In some embodiments, advanced search functions allow the customer to locate products and information by part number. This may be via product type, manufacturer, keyword, description, part numbers, or truncated versions of each. Additionally, some embodiments of the present invention provide a simplified “view” feature that provides a list of manufacturers, complete or sorted by specialty, and a list of product types, again complete or sorted by specialty, on the order template. Finally, all products are displayed on the site with user-specific pricing and a direct link to the order template

In some embodiments, a computer program product performs the method of the present invention. This computer program product includes a storage means onto which is stored means for performing each step of the method. In other embodiments, the computer program product is integrated into a system for performing the method. This system includes a computer having a processor, a connection to an electronic network, and a memory that serves as the data storage means upon which the computer program product is stored.

Therefore, it is an aspect of the invention to provide a purchasing method and system having part numbers of frequently ordered items pre-loaded onto an order form to reduce the risk of error by the insertion of incorrect part numbers and pricing on order forms.

It is a further aspect of the invention to provide a purchasing method and system that displays specific and correct contracted pricing by product, not only on the order form, but in the display of every seller document that is associated with the part number.

It is a further aspect of the invention to provide a purchasing method and system that only requires a login, quantity inserted for each line item desired and a customer instruction to place an order.

It is a further aspect of the invention to provide a purchasing method and system that displays a link to a picture and information regarding the product next to the part number to aid the customer in confirming that the correct item is being purchased.

It is a further aspect of the invention to provide a purchasing method and system that displays purchase history for a customer selected period of time in order to simplify the repurchase of previously purchased products.

It is a further aspect of the invention to provide a purchasing method and system that allows a customer to order from the purchase history screen by inserting a quantity in a box next to the part number in the purchase history such that errors in repurchasing items is minimized.

It is a further aspect of the invention to provide a purchasing method and system that provides a link to peer reviews on any product screen, including on the order form, such that customers can be reinforced on their purchasing decisions.

It is a further aspect of the invention to provide a purchasing method and system that provides a link to available protocols on any product screen, including on the order form, such that customers can be sure of the proper protocol for utilizing the product.

It is a further aspect of the invention to provide a purchasing method and system that allows customers to insert their own internal part number, by line item, to choose the part numbers by which to view items throughout the system, and to allow customers to order or view products via their own internal part numbers rather than the seller's part numbers.

It is a further aspect of the invention to provide a purchasing method and system that displays on the order template product quotes that were provided during a predetermined period such that customer can easily review and purchase a product that was quoted but not previously purchased.

It is a further aspect of the invention to provide a purchasing method and system that provides a status on all orders received by any medium with daily updates such that customers can easily view the status of any order placed with the organization. It is a further aspect of the invention to provide a purchasing method and system that allows a customer to choose a physical location from which the order is being placed such that one user can make purchases for multiple locations without having to manage separate user information.

It is a further aspect of the invention to provide a purchasing method and system that provides a link to “Best Practices” information, which provides suggestions on what products to purchase and what is considered the best in the industry

It is a further aspect of the invention to provide a purchasing method and system that allows for convenient access to latex content, UPN/Bar Code, and PVC content such that those customers interested in this information can easily access it.

It is a further aspect of the invention to provide a purchasing method and system that displays a simplified registration form for current customers such that current customers do not need to include information on their registration form that the seller already has.

It is a further aspect of the invention to provide a purchasing method and system that offers multiple payment options such that customers have a choice between using account methods or credit card methods.

It is a further aspect of the invention to provide a purchasing method and system that allows customers to add “New Products” directly to the shopping cart such that the number of steps needed to make a purchase are decreased and such that the customer does not need to remember the new part number to add it to their order template or cart.

It is a still further aspect of the invention to provide a purchasing method and system that sends both an email confirmation of purchase and an email confirmation of shipping such that the customer can confirm the purchase and status of the order.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a flow diagram showing the basic steps of the method of the present invention.

FIG. 2 is a flow diagram showing a preferred set of choices provided to a customer prior to and following the identification step of the preferred method.

FIG. 3 is a computer screen shot of a user-specific order template entry form.

FIG. 4 is a computer screen shot of a user-specific product information order entry form.

FIG. 5 is a flow diagram of a preferred set of choices provided to a customer following login and transmission of a product history page.

FIG. 6 is a computer screen shot of a user-specific purchase summary order entry form.

FIG. 7 is a computer screen shot of a user-specific purchase detail order entry form.

### DETAILED DESCRIPTION OF THE INVENTION

The present invention provides a registered customer the ability for simplified purchasing of healthcare products via user-specific order entry forms transmitted to the customer via the Internet. The user-specific order entry forms of the present invention reduce the number of user actions needed to place an order, decrease the likelihood of typical errors occurring in the process, and otherwise solve the above noted problems inherent in prior art systems.

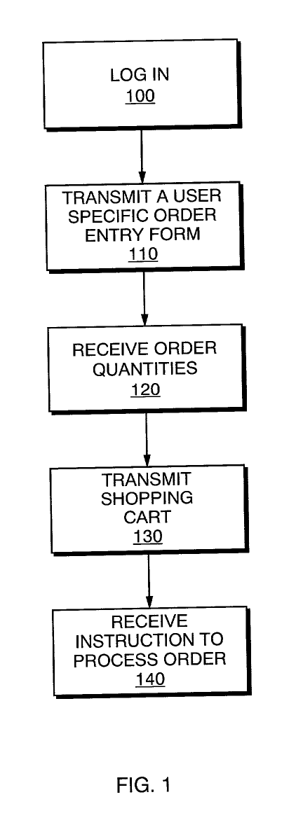

Referring first to FIG. 1, the basic steps of the method of the present invention are illustrated. The first step in this process is for a user to log into the system 100. This step may involve the use of a password protected login screen, recognition of a cookie stored in the memory of the customer's computer, identification of a unique IP address, or other art recognized means for identifying a user over an electronic network. It is noted that the preferred embodiment of the system allows the customer to browse the seller's web page without first logging into the system, but will not display the customer specific pricing, or any other customer specific information, until the user has logged into the system.

Once the user has logged into the system, the system transmits a user-specific order entry form 110 that includes at least one line item made up of a user-specific product identifier, a user-specific price for each product, and a quantity entry field for each product. As described in detail below, the order entry form may take many forms, but in all cases will include the user-specific price for each product and a quantity entry field in which a user may enter the desired quantity for the product.

A user will then enter the desired quantities of desired products and will send this information to the seller, who receives the quantities 120 and transmits a list of products selected by the user 130. This transmittal may be in the form of any art recognized “shopping cart” type display. If the list is correct, the user will send an instruction to proceed with the order, which is received 140 by the seller to complete the transaction. As described in detail below, this instruction may include a choice of a method of payment, specific location account, alternative shipping address, or other information necessary, or desirable, for processing the order.

In a preferred embodiment of the method, a user is required to register over the Internet prior to a first login. In such embodiments, Internet registration causes the server system to assign the purchaser a unique identifier and to make available any previous purchaser-specific account, purchase history, order status, pricing and quoted information which may have been received prior to Internet registration by either phone, fax, email, mail, or EDI. This is preferably accomplished automatically via a mainframe computer, which prepares the appropriate data for the account numbers for which the customer has registered. This information is then transmitted to the Web server, which posts the data to the site. Once posted, the preferred system sends a notification to the registrant, via email, notifying them that their information has been posted to the site and is ready for viewing.

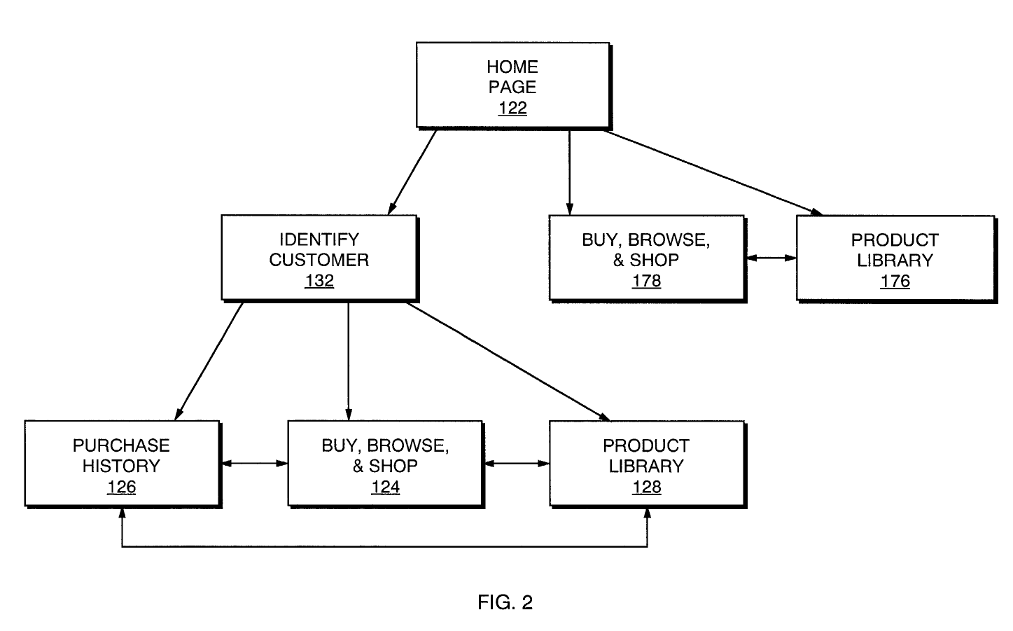

As shown in FIG. 2, in the preferred embodiment a customer logs onto the seller's Internet “home page” 122 and is offered a number of choices for navigating through the site to complete the order process. At this home page 122, the customer is preferably given the choice of proceeding to a Buy, Browse, & Shop page 124, a Purchase History page 126, or a Product Library page 128, which each correspond to a specific order entry form. If a user has not yet performed the login step 132, the user is offered the choice of performing the login step 132 or to proceed to a generic “Buy, Browse, & Shop page 178, or Product Library 176 page. In some embodiments, the customer may choose products from these pages and add them to their virtual shopping cart in the same manner described in detail below. However, the prices displayed are not user specific prices, as no user is specified, and the customer may not actually order products without performing the login step 132.

If a customer performs the login step 132, a customer specific Buy, Browse, & Shop page 124, Purchase History page 126, or Product Library page 128 is displayed. As described in detail below, these pages each provide access to order entry forms having the customer's user specific pricing, and from which quantities may be directly entered for purchase.

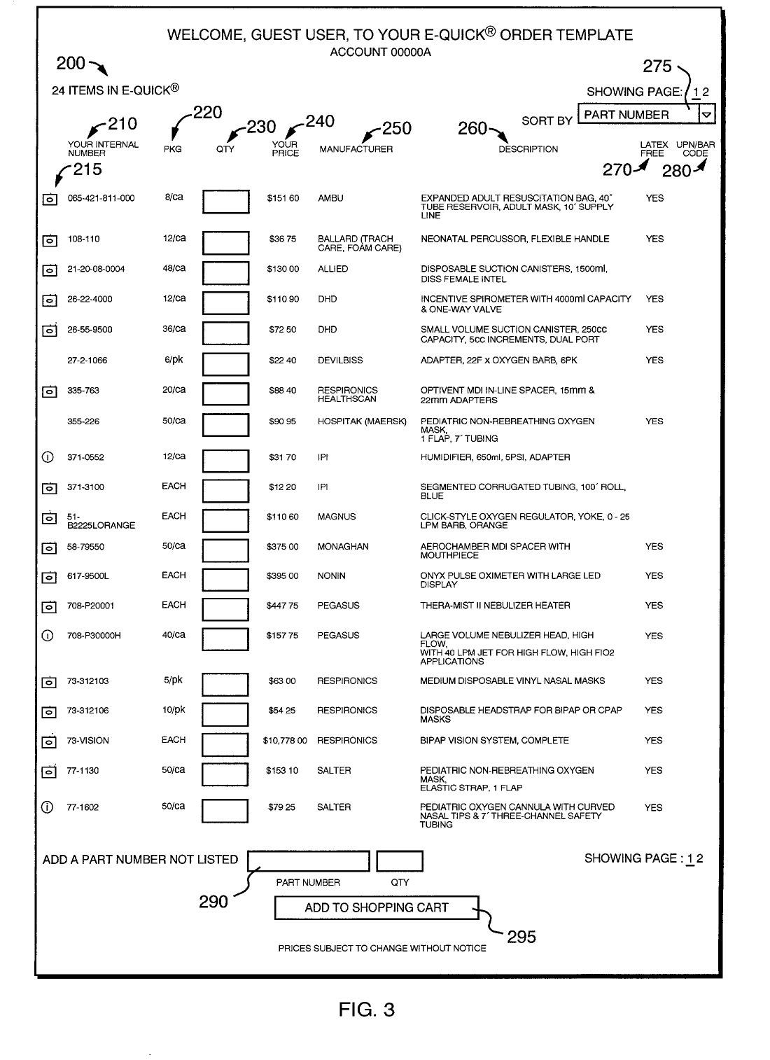

Referring now to FIG. 3, a computer screen shot of the preferred user specific order template entry form 200 is shown. The order template entry form 200 is transmitted when a customer who has performed the login step and chosen the “Buy, Browse, Shop” option. As shown in FIG. 3, the order template entry form 200 includes columns in which are displayed an customer's internal part number 210, a package quantity 220, a quantity entry field 230 into which a user may enter a quantity of a product to be ordered, a customer specific price 240, a manufacturer 250, a description of the product 260, a latex and PVC content indicator 270 and a UPC/barcode indicator 270. However, it is recognized that a variety of other information may also be included, and that some of the information shown may be eliminated, so long as the quantity entry field 230, customer specific price 240, and a description of the product 260 are displayed.

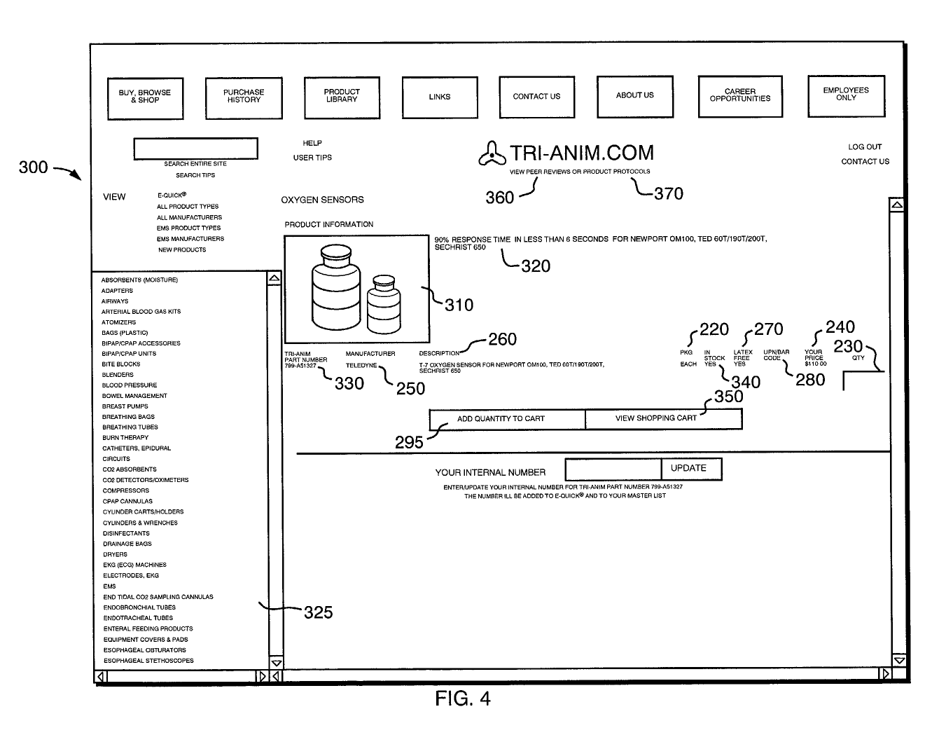

The customer's internal part number 210, shown on the preferred order template entry form 200, is based upon entry of the number 210 by the customer. The ability to allow the customer to enter this number 210, and to have this number displayed on all order entry forms throughout the system, makes it easier for the customer to insure that the part being ordered is the correct part and, therefore, expedites the order entry process. It also provides an additional check on the correctness of the order. As noted below, the customer's internal part number 210 may be entered in entry fields in a number of forms from which the customer may assign any alphanumeric character, or string of characters. In the event that the customer has not entered an internal part number 210, the seller's part number may appear in its place (See FIG. 4). It is recognized, however, that other embodiments of the invention may not display customer internal part number 210, but rather will display only the seller's internal part number.

The package quantity 220, manufacturer 250, and description of the product 260 are non user-specific information that is added to the order template entry form 200 as a further aid to the customer. Although the information itself is not user-specific, it is noted that the choice of the products 260 displayed is user specific. When displayed on the order template entry form 200, this choice of products 260 is based upon prior orders of products 260 within a selected time period, as well as those products 260 entered by the customer into the product entry field 290 displayed at the bottom of the order template 200.

The latex and PVC content indicator 270 and UPC/barcode indicator 270 are both included in the preferred embodiment, as the preferred embodiment of the method relates to the purchase of healthcare products. However, it is understood that this information may be omitted, or replaced with other relevant indicators, in other embodiments of the invention. For example, if the present system were used to sell electrical products, indicators such as Factory Mutual certifications, silicone content, NEMA class compliance, or the like could be included in place of latex and UPC/barcode information. Further, it is also recognized that additional indicators, such as Environmentally Friendly Product (EFP) indicators, may also be added to the display of the indicators described herein.

The price 240 displayed is a customer specific price 240 that is taken directly from a database accessed by the server. This database includes a reference to the customer and a list of all part number for which prices have been designated for, agreed upon by, or quoted to, that particular customer. As noted above, the price 240 displayed will normally differ from customer to customer. However, as in the case of new products that have not been quoted or previously purchased, the customer specific price may simply be list price, which will be used as the customer specific price until a new price is quoted or otherwise agreed upon. In all cases, the correct, customer specific, price 240 will be transmitted by the seller for display by the user whenever a price 240 for that product is transmitted by the seller. The customer specific price for each item is preferably updated daily via a synchronization of customer information between the mainframe computer and the Web server. However, in other embodiments, the information is entered directly into the database on the Web server and, therefore, customer specific prices are up the minute prices for the product. This ability to transmit the customer specific price 240 in this manner is a key feature of the present invention.

The quantity entry field 230 is a customer enterable field that allows the customer to order a desired quantity for each line item product 260. In the preferred order template entry form 200, all product information is displayed in tabular form and this quantity entry field 230 is displayed in on the same line as the other information regarding each product. However, in other embodiments, this quantity entry field 230 may be located at a different location upon the form. In all cases, however, the insertion of quantities into the quantity entry fields 230 and the transmission of this information for receipt by the seller are the only actions required by the customer prior to instructing the seller to process the order.

In the preferred order template entry form 200, the transmission of the product quantity data is accomplished by the customer's choice of the “Add to Shopping Cart” icon 295 at the bottom of the order template entry form 200. In other embodiments of the invention, this instruction is transmitted by simply adding a quantity into the field, by choosing another icon upon the form 200, or by other art recognized means of choosing products for purchase over the Internet.

The preferred order template entry form 200 also includes a sort field 275 that allows a customer to sort and display the product information in a desired order. In the commercial embodiment employed by the assignee of the present invention, this sort field 275 displays a pop-up menu that allows the customer to sort the information by part number, manufacturer, product description and order frequency. However, it is understood that other sort criteria, or other art recognized means for sorting the product information, could be employed to achieve similar results.

In the preferred embodiment, the order template entry form 200 also includes an icon 225 that provides a link to change the information displayed upon the order template entry form 200 from a display of previously purchased products to a display of products that were previously quoted but not yet purchased. This order template entry form 200 includes all of the same information provided with regard to previously purchased products, including a customer specific price 240. Once a previously quoted product 260 is ordered, it will automatically be removed from the quoted product information and will appear on all subsequent order templates entry forms 200 displaying previously ordered products.

Finally, the preferred order template entry form 200 also includes icons 215 that provide to product information forms specific to each product 260. By choosing one of these icons 215, the customer transmits a signal to the seller, who receiving the signal that the link has been chosen and transmits a product information order entry form to back to the customer.

The preferred embodiment of the product information entry form 300 is shown in FIG. 4. The product information order entry form 300 may be accessed via icons 215 in the order template entry form 200, or may be directly accessed through the Product Library page 128, or through the Purchase Summary entry or Detailed Purchase History entry forms described below. The preferred product information order entry form 300 includes all of the product information displayed on the order template entry form 200, such as the manufacturer 250, product description 260, package quantity 220, customer specific price 240, quantity entry field 230, latex content indicator 270, and UPC/barcode indicator 280. In addition, a part number field 330, similar to the internal part number field 210 of the order template entry form 200, is included. This part number field 330 displays the seller's part number until a customer's internal part number is entered within the internal part number entry field 380 at the bottom of the form 300.

The preferred product information order entry form 300 also includes the stock status 340 of the product displayed. In the preferred embodiment, stock status 340 is also provided during the daily update between the mainframe and Web server. In others, stock status 340 is provided through a direct link to the sellers inventory control system and provides real time updates of stock status. In still others, the stock status 340 is included in the product database and is updated manually when products are out of stock. It is recognized that the stock status 340 may also be provided along with the information on any other order entry form, or may be replaced with other similar information, such as estimated delivery time or the like.

The product information order entry form 300 also includes additional product specific information not included in the order template entry form. For example, the preferred form 300 includes an image 310 of the product, which preferably may be enlarged to show a close-up view of the product, and a brief description of its key features 320. This image 310 and description of key features provide an additional means for a customer to insure that they are ordering the correct product. The preferred form 300 also includes an icon 360 that provides a link to peer reviews of the selected product and an icon 370 that provides a link to available product protocols for the selected product. These links may also be accessed through the Product Library page 128 and provide the customer with an additional level of security that they are ordering the correct part. In some embodiments of the invention, peer review and product protocol pages take the form of additional order entry forms, having the same features as those described elsewhere herein. In others, these pages are purely informational and do not provide the customer with the option of placing an order.

In some embodiments, a Best Practices order entry form (not shown) may also be accessed via the Product Library page 128. The preferred Best Practices order entry form includes a list of the best products in a particular product type or category. For example, the seller might say that the Company X Rhesus bag is the best in the category for Rhesus bags. The user can then view the “best practice” template, from which they can place an order in the same manner as the user-specific template. In the preferred embodiment of the invention, the user can also compare their purchase history order entry form to the best practice order entry form, and place an order in the same manner as previous templates by entering a quantity in either form. As was the case with all other order entry forms, the Best Practices order entry form also includes a customer specific price and a quantity entry field that allow the customer to place the order.

Finally, the preferred product information entry form 300 includes a frame in which icons 325 provide links to all product categories. These links may also be accessed through the Product Library page 128 and allow the customer to view information on products that have not been previously ordered or quoted. Once such a product is chosen, an updated product information entry form 300 is displayed with the information relating to the chosen product and a customer specific price for that product.

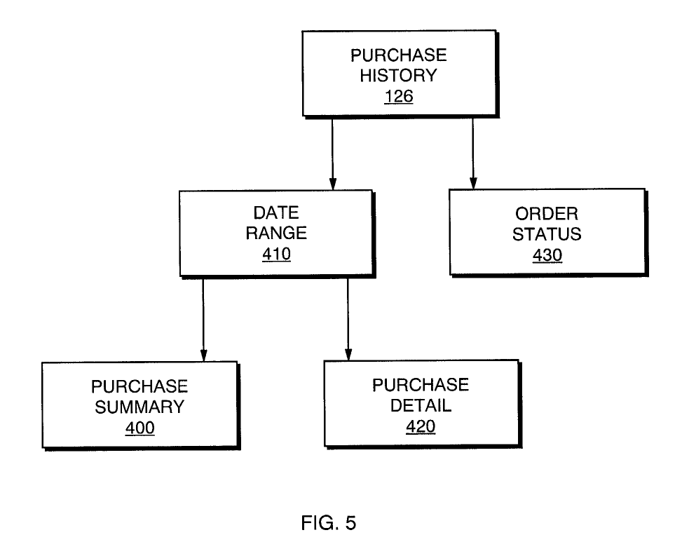

As noted above, in addition to the customer specific Buy, Browse, & Shop page 124 and Product Library page 128, the customer may also elect to place an order through the Purchase History page 126. As shown in FIG. 5, once a user logs into the Purchase History page 126, the customer is provided with the option of viewing an order status page 430, or entering a date range 410 from which the server will generate a purchase summary order entry form 400 or a purchase detail order entry form 420.

The preferred order status page 430 includes the purchase order number, the products on the order, shipping status of each product, a date of shipment, and a place of shipment. The preferred order status page 430 does not require that a date range 410 be provided by the customer, but rather is set at a desired number of months by the seller. However, it is understood that the order status page 430 could be preceded by an entry page for a date range 410 and that the display of order status information on the order status page 430 could be customized by date. Likewise, the preferred order status page 430 is an informational page only and does not serve as an order entry form from which products may be reordered. However, it is also understood that the order status page 430 is readily adaptable for this function.

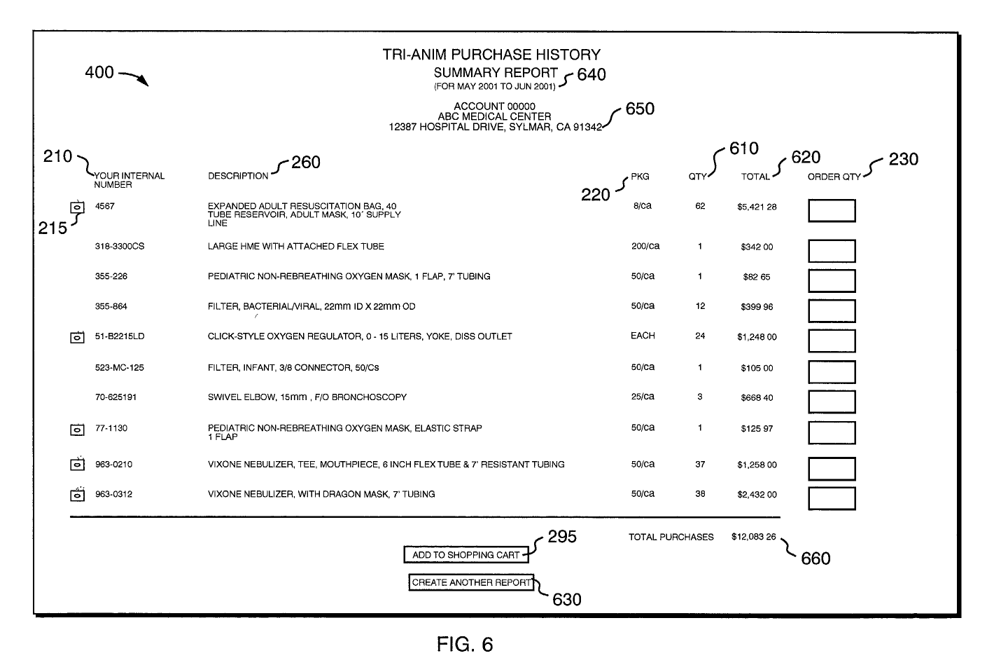

As shown in FIG. 6, the preferred purchase summary page 400 includes much of the same information shown in the order template entry form 200 described above, including the customer's internal part number 210, a package quantity 220, a quantity entry field 230 into which a user may enter a quantity of a product to be ordered, and an icon 215 to link to a product information entry page 300. However, the preferred summary page 400 omits the other information and replaces it with a quantity ordered 610 for a specified time period and a customer specific total price 620 for orders of that product during the specified time frame. In addition to the price and description information, the preferred purchase summary page 400 also includes the customer name and address 650, the date range 640 of the report, the same add to shopping cart icon 295 described above, and a new report icon 630 that allows a different report format to be generated. Finally, the summary page 400 includes a total of purchase 660 that were made during the specified date range.

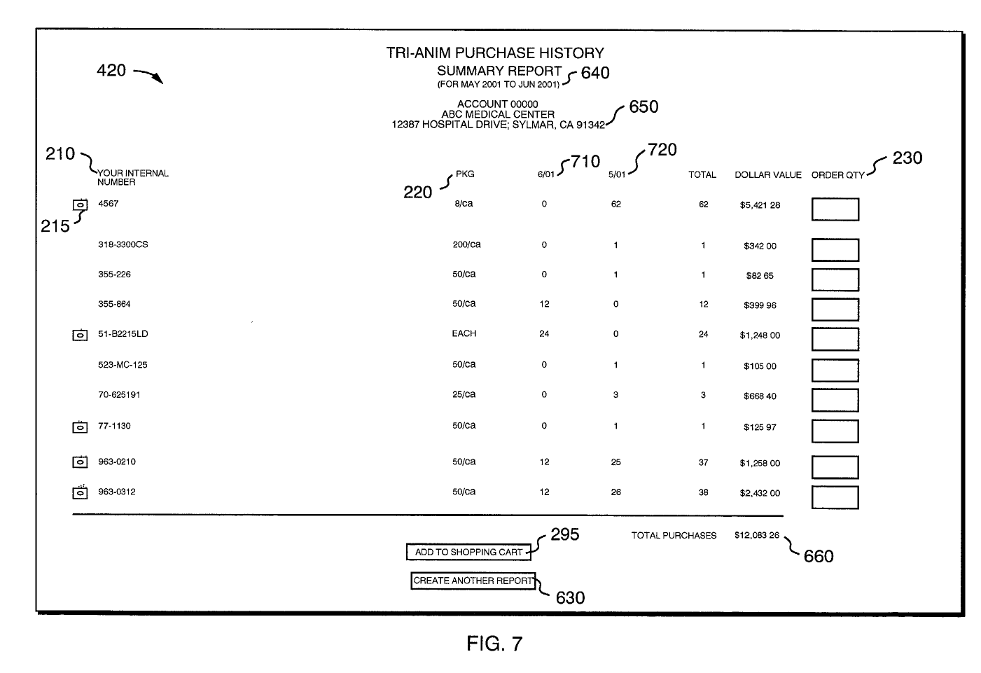

The preferred purchase detail order entry form 420 is shown in FIG. 7. This form 420 is similar in many respects to the purchase summary order entry form 400, except that some information is omitted and the order quantity 610 is broken down into monthly order quantity fields 710, 720.

Regardless of which order entry form is used, once the customer has finished entering quantities of products, the seller will receive the quantities and transmit an Internet “shopping cart” to the user. The shopping cart may be any art recognized checkout means that displays products ordered, quantities thereof, and the price to be paid. In the preferred embodiment, the shopping cart screen allows customers to edit quantities or products to be ordered, or to add new products. In addition, the preferred shopping cart includes links to all other pages described herein, allowing the customer to resume shopping before checkout.

Once the customer views to the shopping cart and reviews the information contained therein, the customer accepts the order and a signal is transmitted to the seller, who then may process the order. In the preferred embodiment, the processing of the order is confirmed automatically via an email message sent to the customer. However, in other embodiments, traditional order confirmation methods are utilized to achieve similar results.

The methods described above are readily adapted for integration into a computer program product that may be purchase by sellers and loaded upon their computer systems. The development of a program product to perform the method of the present invention is a straightforward task that is well within the skill of those in the art. Accordingly, preferred program routines have not been described in detail herein.

In some embodiments of the invention, the computer program product is integrated directly into a computer system and sold as a package to sellers. In such an embodiment, the system includes a computer having a processor, a connection to an electronic network, and a memory that serves as the data storage means upon which the computer program product is stored.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method for selling products over an electronic network, said method comprising the steps of:
identifying a user;
transmitting a user specific order entry form, said order entry form comprising at least one user specific product, a user specific price for said at least one product, and a quantity entry field;
receiving a quantity of at least one product entered into said quantity entry field by said user;
transmitting a shopping cart comprising each of said at least one product selected by the user; and
receiving an instruction from said user to process an order.

2. The method as claimed in claim 2 wherein said step of transmitting a user Specific order entry form comprises transmitting a user specific order entry form that further comprises an internal part number associated with at least one previously ordered product.

3. The method as claimed in claim 1 wherein said step of transmitting a user specific order entry form comprises transmitting a user specific order template, said order template further comprising at least one previously ordered product.

4. The method as claimed in claim 1 wherein said step of transmitting a user specific order template comprises transmitting a user specific order template that further comprises a new product entry field.

5. The method as claimed in claim 1 wherein said step of transmitting a user specific order entry form comprises transmitting a user specific order template, said order template further comprising at least one previously quoted product.

6. The method as claimed in claim 1 wherein said step of transmitting a user specific order entry form to said user comprises transmitting a user specific purchase history form, said purchase history form further comprising at least one previously ordered product that was purchased during a specified time period.

7. The method as claimed in claim 6 wherein said method further comprises the steps of:
displaying a date range form comprising at least one date entry field, said step of displaying a date range form being performed prior to said step of said step of transmitting a user specific purchase history form; and
receiving a date entered into said date entry field by said user;
wherein said step of transmitting a user specific purchase history form comprises transmitting a user specific purchase history form at least one previously ordered product that was purchased during a time period based upon said date.

8. The method as claimed in claim 6 wherein said step of transmitting a user specific purchase history form, comprises transmitting a said purchase history form further comprising a total of said at least one previously ordered product that was purchased during said specified time period.

9. The method as claimed in claim 1 wherein said step of transmitting a user specific order entry form comprises transmitting a user specific order entry form that further comprises an icon having a link to a product information order entry form, and wherein said method further comprises the steps of receiving a signal that said link has been chosen and transmitting said product information order entry form to said user.

10. The method as claimed in claim 1 wherein said step of transmitting a user specific order entry form comprises transmitting a user specific order entry form that further comprises an icon having a link to a peer review form, and wherein said method further comprises the steps of receiving a signal that said link has been chosen and transmitting said peer review form to said user.

11. The method as claimed in claim 1-wherein said step of transmitting a user specific order entry form comprises transmitting a user specific order entry form that further comprises an icon having a link to a product protocol form, and wherein said method further comprises the steps of receiving a signal that said link has been chosen and transmitting said product protocol form to said user.

12. The method as claimed in claim 1 wherein said step of transmitting a user specific order entry form comprises transmitting a user specific order entry form that further comprises a sort field, and wherein said method further comprises the steps of receiving a sort criterion entered into said sort field, sorting said at least one user specific product, and said user specific price for said at least one product, into a desired order based upon said sort criterion, and displaying a resulting list of said at least one user specific product said user specific price for said at least one product in said desired order.

13. The method as claimed in claim 1 further comprising the steps of transmitting a payment option form and receiving an instruction from said user to utilize a specified payment option.

14. The method as claimed in claim 1 further comprising the steps of transmitting a facility option form and receiving an instruction from said user to utilize a specified facility option

15. A computer program product for selling products over an electronic network, said computer program product comprising:
means for identifying a user;
means for transmitting a user specific order entry form, said order entry form comprising at least one user specific product, a user specific price for said at least one product, and a quantity entry field;
means for receiving a quantity of at least one product entered into said quantity entry field by said user;
means for transmitting a shopping cart comprising each of said at least one product selected by the user; and
means for receiving an instruction from said user to process an order.

16. The computer program product as claimed in claim 15 wherein said means for transmitting a user specific order entry form comprises a means for transmitting a user specific order entry form that further comprises an internal part number associated with at least one previously ordered product.

17. The computer program product as claimed in claim 151 wherein said means for transmitting a user specific order entry form comprises a means for transmitting a user specific order template further comprising at least one previously ordered product.

18. The computer program product as claimed in claim 15 wherein said means for transmitting a user specific order template comprises means for transmitting a user specific order template that further comprises a new product entry field.

19. The computer program product as claimed in claim 15 wherein said means for transmitting a user specific order entry form comprises a means for transmitting a user specific order template comprising at least one previously quoted product.

20. The computer program product as claimed in claim 15 wherein said means for transmitting a user specific order entry form comprises a means for transmitting a user specific purchase history form further comprising at least one previously ordered product that was purchased during a specified time period.

21. The computer program product as claimed in claim 20 further comprising:
means for displaying a date range form comprising at least one date entry field, said step of displaying a date range form being performed prior to said step of said step of transmitting a user specific purchase history form; and
means for receiving a date entered into said date entry field by said user;
wherein said means for transmitting a user specific purchase history form comprises means for transmitting a user specific purchase history form at least one previously ordered product that was purchased during a time period based upon said date.

22. The computer program product as claimed in claim 21 wherein said means for transmitting a user specific purchase history form further comprises a means for a total of said at least one previously ordered product that was purchased during said specified time period.

23. The computer program product as claimed in claim 15 wherein said means for transmitting a user specific order entry form comprises a means for transmitting a user specific order entry form that further comprises an icon having a link to a product information form, and wherein said computer program product further comprises a means for receiving a signal that said link has been chosen and a means for transmitting said product information form to said user

24. The computer program product as claimed in claim 15 wherein said means for transmitting a user specific order entry form comprises an icon having a link to a peer review form, and wherein said computer program product further comprises a means for receiving a signal that said link has been chosen and a means for transmitting said peer review form to said user.

25. The computer program product as claimed in claim 15 wherein said means for transmitting a user specific order entry form further comprises an icon having a link to a product protocol form, and wherein said computer program product further comprises a means for receiving a signal that said link has been chosen and a means for transmitting said product protocol form to said user.

26. The computer program product as claimed in claim 15 wherein said means for transmitting a user specific order entry form comprises a means for transmitting a user specific order entry form that further comprises a sort field, and wherein said computer program product further comprises a means for receiving a sort criterion entered into said sort field, a means for sorting said at least one user specific product, and said user specific price for said at least one product, into a desired order based upon said sort criterion, and a means for displaying a resulting list of said at least one user specific product said user specific price for said at least one product in said desired order.

27. The computer program product as claimed in claim 15 further comprising a means for transmitting a payment option form and a means for receiving an instruction from said user to utilize a specified payment option.

28. The computer program product as claimed in claim 15 further comprising a means for transmitting a facility option form and a means for receiving an instruction from said user to utilize a specified facility option.

29. A system for selling products over an electronic network, said system comprising:
a computer comprising a processor, a memory, and a connection to said electronic network; and
a computer program product stored in said memory and executable by said processor of said computer, said computer program product comprising:
means for identifying a user;
means for transmitting a user specific order entry form, said order entry form comprising at least one user specific product, a user specific price for said at least one product, and a quantity entry field;
means for receiving a quantity of at least one product entered into said quantity entry field by said user;
means for transmitting a shopping cart comprising each of said at least one product selected by the user; and
means for receiving an instruction from said user to process an order.

30. The system as claimed in claim 29 wherein said means for transmitting a user specific order entry form comprises a means for transmitting a user specific order entry form that further comprises an internal part number associated with at least one previously ordered product.

31. The system as claimed in claim 29 wherein said means for transmitting a user specific order entry form comprises a means for transmitting a user specific order template further comprising at least one previously ordered product.

32. The system as claimed in claim 29 wherein said means for transmitting a user specific order template comprises means for transmitting a user specific order template that further comprises a new product entry field.

33. The system as claimed in claim 29 wherein said means for transmitting a user specific order entry form comprises a means for transmitting a user specific order template comprising at least one previously quoted product.

34. The system as claimed in claim 29 wherein said means for transmitting a user specific order entry form comprises a means for transmitting a user specific purchase history form further comprising at least one previously ordered product that was purchased during a specified time period.

35. The system as claimed in claim 34 further comprising:
means for displaying a date range form comprising at least one date entry field, said step of displaying a date range form being performed prior to said step of said step of transmitting a user specific purchase history form; and
means for receiving a date entered into said date entry field by said user;
wherein said means for transmitting a user specific purchase history form comprises means for transmitting a user specific purchase history form at least one previously ordered product that was purchased during a time period based upon said date.

36. The system as claimed in claim 35 wherein said means for transmitting a user specific purchase history form comprises a means for transmitting a purchase history form further comprising a total of said at least one previously ordered product that was purchased during said specified time period.

37. The system as claimed in claim 29 wherein said means for transmitting a user specific order entry form comprises a means for transmitting a user specific order entry form that further comprises an icon having a link to a product information form, and wherein said computer program product further comprises a means for receiving a signal that said link has been chosen and a means for transmitting said product information form to said user

38. The system as claimed in claim 29 wherein said means for transmitting a user specific order entry form comprises an icon having a link to a peer review form, and wherein said computer program product further comprises a means for receiving a signal that said link has been chosen and a means for transmitting said peer review form to said user.

39. The system as claimed in claim 29 wherein said means for transmitting a user specific order entry form further comprises an icon having a link to a product protocol form, and wherein said computer program product further comprises a means for receiving a signal that said link has been chosen and a means for transmitting said product protocol form to said user.

40. The system as claimed in claim 29 wherein said means for transmitting a user specific order entry form comprises a means for transmitting a user specific order entry form that further comprises a sort field, and wherein said computer program product further comprises a means for receiving a sort criterion entered into said sort field, a means for sorting said at least one user specific product, and said user specific price for said at least one product, into a desired order based upon said sort criterion, and a means for displaying a resulting list of said at least one user specific product said user specific price for said at least one product in said desired order.

41. The system as claimed in claim 29 further comprising a means for transmitting a payment option form and a means for receiving an instruction from said user to utilize a specified payment option.

42. The system as claimed in claim 29 further comprising a means for transmitting a facility option form and a means for receiving an instruction from said user to utilize a specified facility option.
